(19) United States
(12) Patent Application Publication
(10) Pub. No.: US 2015/0007196 A1
(43) Pub. Date: Jan. 1, 2015

(54) PROCESSORS HAVING HETEROGENEOUS CORES WITH DIFFERENT INSTRUCTIONS AND/OR ARCHITECURAL FEATURES THAT ARE PRESENTED TO SOFTWARE AS HOMOGENEOUS VIRTUAL CORES

(71) Applicant: Intel Corporation, Santa Clara, CA (US)

(72) Inventors: BRET L. TOLL, Hillsboro, OR (US); Jason W. Brandt, Austin, TX (US); Eliezer Weissmann, Haifa (IL); Inder M. Sodhi, Folsom, CA (US); David A. Koufaty, Portland, OR (US); Scott D. Hanh, Portland, OR (US)

(21) Appl. No.: 13/931,657

(22) Filed: Jun. 28, 2013

(51) Int. Cl. G06F 9/50

(52) U.S. Cl. CPC G06F 9/5083
USPC 718/105

(57) ABSTRACT

A processor of an aspect includes a first heterogeneous physical compute element having a first set of supported instructions and architectural features, and a second heterogeneous physical compute element having a second set of supported instructions and architectural features. The second set of supported instructions and architectural features is different than the first set of supported instructions and architectural features. The processor also includes a workload and architectural state migration module coupled with the first and second heterogeneous physical compute elements. The workload and state migration module is operable to migrate a workload and associated architectural state from the first heterogeneous physical compute element to the second heterogeneous physical compute element in response to an attempt by the workload to perform at least one of an unsupported instruction and an unsupported architectural feature on the first heterogeneous physical compute element.

### BACKGROUND

1. Technical Field

Embodiments relate to processors. In particular, embodiments relate to processors having heterogeneous cores or other processing elements.

2. Background Information

Heterogeneous core processors have two or more heterogeneous or different types of cores that are available to perform computational tasks. Under certain circumstances the heterogeneous core processors may offer advantages over homogenous core processors having cores of the same type. In some cases, different types of cores may tend to be better suited than others at performing different tasks. For example, a core of type A may be faster than a core of type B at performing a task X, but the core of type A may be slower than the core of type B at performing a different task Y. As a result, a processor having cores of both type A as well as type B may potentially be more efficient at performing a combination of tasks X and Y than a processor that only has cores of type A or type B, but not both. In other cases, different types of cores may have different rates of power consumption. For example, the core of type A may consume more power than the core of type B when performing the task X. As a result, at times when reducing power consumption is desired, it may be beneficial to perform the task X on the core of type B rather than the core of type A.

Conventionally there have been challenges to realizing the potential advantages offered by heterogeneous core processors. For one thing, software generally needs to know how to schedule the different tasks on the heterogeneous cores in order to take advantage of their different characteristics. In many conventional computer systems, the scheduling of threads and other workloads to cores is performed by a software module (e.g., a scheduler module, operating system module, virtual machine monitor module, etc.). However, currently there is very limited to no support from major operating systems for harnessing the different characteristics of the heterogeneous cores. In addition, conventionally during boot up the basic input output system (BIOS) would also need to be aware of the heterogeneous cores and provide certain support. However, there is conventionally very limited to no support from BIOS. Moreover, as the processors and their heterogeneous cores change over time, it generally tends to be difficult and/or costly to modify the operating system and/or the BIOS so that it remains consistent with the changes and is able to harness the advantages offered by the different characteristics of the heterogeneous cores.

### BRIEF DESCRIPTION OF THE DRAWINGS

The invention may best be understood by referring to the following description and accompanying drawings that are used to illustrate embodiments of the invention. In the drawings:

FIG. 1 is a block diagram of a computer system.

FIG. 2 is a block diagram of a processor having an example embodiment of heterogeneous physical cores.

FIG. 3 is a block diagram of an embodiment of a processor having heterogeneous physical cores and a workload and architectural state migration module to perform workload and architectural state migration based on an unsupported instruction.

FIG. 4 is a block diagram of an embodiment of a processor having heterogeneous physical cores and a workload and architectural state migration module to perform workload and architectural state migration based on an unsupported architectural feature.

FIG. 5 is a block flow diagram of an embodiment of a method performed by and/or within a processor.

FIG. 6 is a block diagram of an example embodiment of a workload and architectural state migration module.

FIG. 7A is a block diagram illustrating both an exemplary in-order pipeline and an exemplary register renaming, out-of-order issue/execution pipeline according to embodiments of the invention.

FIG. 7B is a block diagram illustrating both an exemplary embodiment of an in-order architecture core and an exemplary register renaming, out-of-order issue/execution architecture core to be included in a processor according to embodiments of the invention.

FIG. 8A is a block diagram of a single processor core, along with its connection to the on-die interconnect network and with its local subset of the Level 2 (L2) cache, according to embodiments of the invention.

FIG. 8B is an expanded view of part of the processor core in FIG. 8A according to embodiments of the invention.

FIG. 9 is a block diagram of a processor that may have more than one core, may have an integrated memory controller, and may have integrated graphics according to embodiments of the invention.

FIG. 10 shown is a block diagram of a system in accordance with one embodiment of the present invention.

FIG. 11 shown is a block diagram of a first more specific exemplary system in accordance with an embodiment of the present invention.

FIG. 12 shown is a block diagram of a second more specific exemplary system in accordance with an embodiment of the present invention.

FIG. 13 shown is a block diagram of a SoC in accordance with an embodiment of the present invention.

FIG. 14 is a block diagram contrasting the use of a software instruction converter to convert binary instructions in a source instruction set to binary instructions in a target instruction set according to embodiments of the invention.

### DETAILED DESCRIPTION OF EMBODIMENTS

Disclosed herein are processors having heterogeneous physical cores or other physical compute elements with different supported instructions and/or architectural features, which are presented to software as homogeneous virtual cores. In the following description, numerous specific details are set forth (e.g., specific numbers of cores, types of heterogeneity among cores, logic implementations and microarchitectural details, logic partitioning/integration details, sequences of operations, types and interrelationships of system components, and the like). However, it is understood that embodiments of the invention may be practiced without these specific details. In other instances, well-known circuits, structures and techniques have not been shown in detail in order not to obscure the understanding of this description.

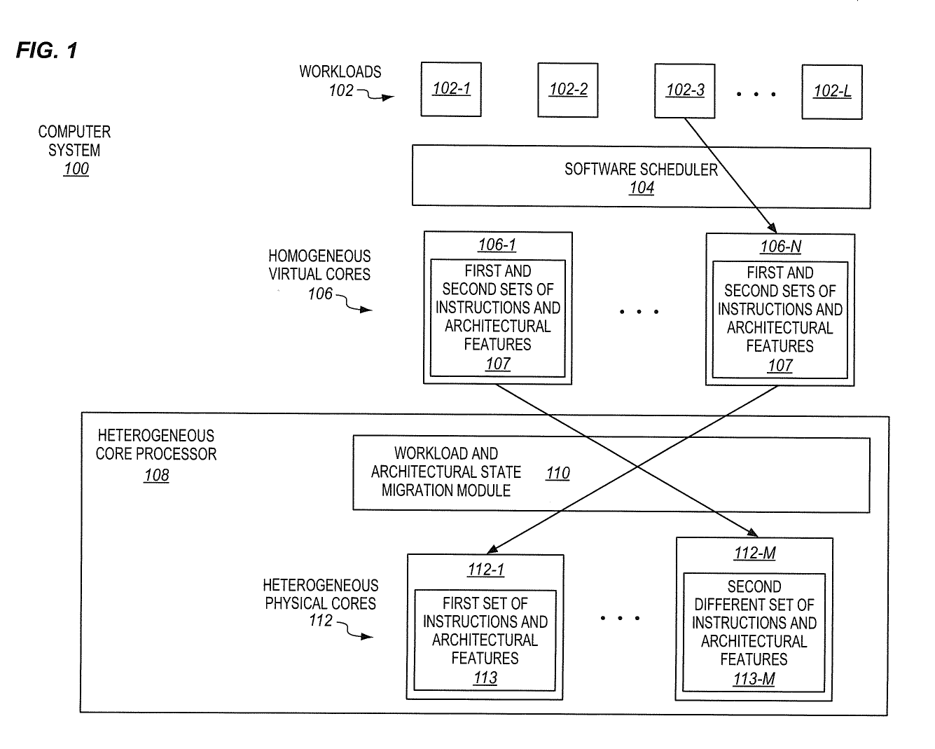

FIG. 1 is a block diagram of a computer system 100. In various embodiments, the computer system may represent a desktop computer, laptop computer, notebook computer, tablet computer, netbook, smartphone, cellular phone, personal digital assistant, Mobile Internet device (MID), media player, server, network device (e.g., router or switch), smart television, set-top box, video game controller, or other type of electronic device having at least one processor incorporating an embodiment disclosed herein.

The computer system includes an embodiment of a heterogeneous core processor 108. The heterogeneous core processor represents a physical processor, integrated circuit, die, or a package thereof. In some embodiments, the heterogeneous core processor may be a general-purpose processor (e.g., of the type often used as a central processing unit (CPU) in desktop, laptop, and like computers). Alternatively, the heterogeneous core processor may be a special-purpose processor. Examples of suitable special-purpose processors include, but are not limited to, network processors, communication processors, cryptographic processors, graphics processors, co-processors, embedded processors, digital signal processors (DSPs), and controllers (e.g., microcontrollers), to name just a few examples. The processor may be any of various complex instruction set computing (CISC) processors, various reduced instruction set computing (RISC) processors, various very long instruction word (VLIW) processors, various hybrids thereof, or other types of processors entirely.

The illustrated heterogeneous core processor 108 has a plurality of heterogeneous physical cores 112. The term core often refers to logic located on an integrated circuit that is capable of maintaining an independent architectural state (e.g., an execution state), in which the independently maintained architectural state is associated with dedicated execution resources. State is also sometimes referred to as context. In contrast, the term hardware thread often refers to logic located on an integrated circuit that is capable of maintaining an independent architectural state, in which the independently maintained architectural state shares access to the execution resources it uses. When certain resources (e.g., execution resources, etc.) are shared by an architectural state, and others are dedicated to the architectural state, the line between a core and a hardware thread is less distinct. Nevertheless, the core and the hardware thread are often viewed by an operating system as individual processing elements, compute elements, or logical processors. The operating system is generally able to schedule operations separately on each of the cores, hardware threads, processing elements, compute elements, or logical processors. In other words, a processing element, compute element, or logical processor, in one embodiment, may represent any on-die processor logic (e.g., integrated circuitry potentially combined with one or more of firmware and/or software) capable of being independently associated with code, such as a software thread, workload, operating system code, application code, or other code, and having conventional pipeline stages (e.g., fetch, decode, execute, etc.)

While many of the embodiments herein show physical cores as examples of the processing elements, compute elements, or logical processors, in other embodiments these physical cores may be replaced by other types of processing elements, compute elements, or logical processors. Examples of such other processing elements, compute elements, or logical processors include, but are not limited to, cores, hardware threads, thread units, thread slots, and/or other multiple pipeline stage logic that is capable of holding state and being independently associated with code. Moreover, still other examples of suitable processing elements, compute elements, or logical processors include, but are not limited to, hardware accelerators, fixed function accelerators, graphics accelerators, specialized processing units, and the like.

Referring again to FIG. 1, the heterogeneous core processor 108 includes a first heterogeneous physical core 112-1 through an Mth heterogeneous physical core 112-M. The heterogeneous core processor may have any appropriate number of heterogeneous cores, processing elements, compute elements, or logical processors desired for the particular implementation. Generally the number may range from two to several hundred, often from two to on the order of tens (e.g., ten to one hundred). In certain embodiments, there may be between about 2 to 100, or about 2 to 50, or about 2 to 30, although the scope of the invention is not so limited. The cores may be coupled with one another by one or more on-die or on-substrate interconnect structures (not shown), such as, for example, a ring, torus, mesh, or other known interconnect structure.

The heterogeneous physical cores have heterogeneous or different characteristics. In the illustration, this heterogeneity is conceptually depicted by the different sizes of the physical cores. However, it is to be appreciated that the actual sizes of the heterogeneous physical cores may either be the same or different. For simplicity in the illustration, only two different types of heterogeneous physical cores are shown. However, in other embodiments there may be three, four, or more different types of heterogeneous physical cores.

In some embodiments, the heterogeneous physical cores may have different instruction sets and/or architectural features (or in some cases different approaches for supporting the same architectural features, such as, for example, System Management Mode (SMM), MC, etc.). As shown, in some embodiments, the first heterogeneous physical core may have a first set of supported instructions and architectural features 113-1, whereas the Mth heterogeneous physical core may have a second different set of supported instructions and architectural features 113-M. In some embodiments, the heterogeneous physical cores may have overlapping but different instruction sets. For example, one or more instructions may be included in the instruction set of the Mth heterogeneous physical core 112-M, but these one or more instructions may not be included in the instruction set of the first heterogeneous physical core 112-1. In some embodiments, the heterogeneous physical cores may share a majority of the instructions (i.e., more than 50%), or in some cases a vast majority of the instructions (i.e., more than 70-90%), or in some cases almost all of the instructions (i.e., more than 97%) of their respective instruction sets, but other instructions included in the instruction set of certain of the heterogeneous physical cores may be missing from the instruction set of other of the heterogeneous physical cores. So much overlap is not required but will be the case in certain implementations. In some cases, certain classes or types of instructions may be supported on some of the physical cores but not other of the physical cores. For example, some cores may support wide packed data instructions (e.g., 256-bit, 512-bit, 1024-bit, etc.), whereas others either may not support packed data instructions or may only support narrower packed data instructions (e.g., 64-bit or 128-bit). In some embodiments, the instruction set and/or architectural features of one of the heterogeneous physical cores may be a superset of the instruction set of one or more others of the heterogeneous physical cores. In some embodiments features may support different in one core then in the second one

The architectural feature may represent an architectural capability, resource, set of logic, operation mode, privilege, or other architectural feature of the processor. One specific example of an architectural feature is an architectural security feature. For example, one type of core may support an architectural security resource, mode, or other feature. By way of example, the architectural security feature may allow all memory traffic or transactions to be encrypted before being sent out to memory and decrypted when being read from memory. Software (e.g., workloads, an operating system, etc.) may attempt to use such an architectural security feature, for example, by changing one or more bits in a control or configuration register, executing a particular instruction, etc. However, if such an attempt is made on another type of core that does not support that architectural security feature (e.g., does not have the encryption unit), then this may represent an internal migration trigger condition to the processor to cause the workload to be migrated to the other type of core that does support the architectural security feature. This internal migration trigger condition may be internal to the processor and hidden from software (e.g., hidden from an operating system module).

Another specific example of an architectural feature is an architectural transactional memory feature. For example, one type of core may support the architectural transactional memory resource, mode, or other feature, whereas another type of core may not. By way of example, the architectural transactional memory feature may allow a workload to enter a transactional execution region. Software (e.g., workloads, an operating system, etc.) may attempt to use such an architectural transactional memory feature, for example, by changing one or more bits in a control or configuration register, executing a particular instruction, etc. However, if such an attempt is made on another type of core that does not support that architectural transactional memory feature, then this may represent an internal migration trigger condition to the processor to cause the workload to be migrated to the other type of core that does support the architectural transactional memory feature. Still other examples of architectural features are other architectural security, cryptographic, privileged access, or other features.

As previously mentioned, often a software module a software module (e.g., a scheduler module, operating system module, virtual machine monitor module, etc.) provides very limited to no support for such heterogeneity among the physical cores. For example, some operating systems assume that all cores have the same instructions and architectural features and breaking this assumption can cause errors or other problems. One possible approach is to disable support for instructions or architectural features that are different among the different physical cores. However, often this approach is not desirable. For example, this approach may tend to sacrifice many of the potential advantages offered by the heterogeneity of the cores. An example is the system management mode which is often supported by only a single type of physical core. An example of a case where it is generally not feasible to disable a feature in one of the core types is machine check, which is often different for each core type but often utilizes a certain amount of common support. Other approaches (e.g., that allow supporting the superset of instructions and architectural features of all the cores) would therefore be advantageous.

In some embodiments, the processor may hide the heterogeneity of the physical cores from software. Referring again to FIG. 1, the processor may present or expose a set of one or more homogeneous virtual cores 106 to software, for example, to a software scheduler 104 and/or an operating system. In the illustration the homogeneity is conceptually depicted by the homogeneous virtual cores being the same size. The number of homogeneous virtual cores exposed to the software may be any appropriate number desired for the particular implementation. Often, the number of exposed homogeneous virtual cores may range from one to several hundred, often from one to on the order of tens (e.g., ten to one hundred). There may either be an equal number of homogeneous virtual and heterogeneous physical cores, or a different number (e.g., more heterogeneous physical cores than homogeneous virtual cores).

The homogeneous virtual cores may appear homogeneous rather than heterogeneous to the software scheduler 104 and/or the operating system. In addition, the homogeneous virtual cores may appear homogeneous to the BIOS during boot up. The processor exposing the homogeneous virtual cores to the software scheduler and/or the operating system and/or the BIOS may effectively hide the heterogeneity of the heterogeneous physical cores from the software scheduler and/or the operating system. The software scheduler and/or the operating system does not need to know about the heterogeneity of the physical cores, but rather may schedule threads, tasks, software processes, or other workloads 102 on the exposed homogeneous virtual cores much as it would in a true homogeneous multi-core processor or multi-processor system. In the illustration this scheduling is depicted by the arrows from the workloads to the homogeneous virtual cores.

In some embodiments, each of the homogeneous virtual cores may appear to have the full or collective set of instructions and architectural features of all of the heterogeneous physical cores, although the scope of the invention is not so limited. That is, in some embodiments, each of the homogeneous virtual cores may appear to support the full range of heterogeneity of the complete set of heterogeneous physical cores. As shown, in some embodiments, the first homogeneous virtual core 106-1 may support the combined first and second sets of instructions and architectural features 107. Similarly, in some embodiments, the Nth homogeneous virtual core 106-N may support the same combined first and second sets of instructions and architectural features 107. By way of example, each of the combined sets of instructions and architectural features may support all instructions executable on any of the heterogeneous physical cores, which may have different instruction sets. As another example, each of the combined sets of instructions and architectural features may support all of the architectural features supported by any of the heterogeneous physical cores.

In some embodiments, there may be an initial or default mapping between the software visible homogeneous virtual cores and the software invisible heterogeneous physical cores. For example, in some embodiments, each homogeneous virtual core may initially correspond to a heterogeneous physical core in a default or otherwise predetermined way. In other embodiments, the initial mapping between the homogeneous virtual cores and the heterogeneous physical cores may be dynamically determined. For example, when a workload is scheduled on a homogeneous virtual core, the processor may dynamically select and map a corresponding heterogeneous physical core. In some embodiments, the processor may dynamically determine a mapping that satisfies criteria or helps to achieve a certain advantage (e.g., improved performance or speed, reduced power consumption, etc.). For example, the mapping may be in a way that helps to improve performance (e.g., mapping a workload onto a faster or more powerful physical core), or reduce power consumption (e.g., mapping the workload onto a smaller more power efficient physical core), etc. The mapping may be performed to take advantage of any of the various potential advantages known in the arts for heterogeneous physical core processors. In other embodiments it is not required to use just one-to-one mappings between homogeneous virtual and heterogeneous physical cores. For example, multiple homogeneous virtual cores may potentially be mapped to the same heterogeneous physical core (e.g., may execute on different threads).

In some embodiments, the mapping or correspondence between homogeneous virtual cores and heterogeneous physical cores may be dynamically modified or changed during runtime. Referring again to FIG. 1, the processor includes an embodiment of a workload and architectural state migration module 110. The workload and architectural state migration module may be implemented in hardware (e.g., integrated circuitry, transistors or other circuit elements, etc.) and/or firmware (e.g., ROM, EPROM, flash memory, or other persistent or non-volatile memory and microcode, microinstructions, or other hardware level instructions or control signals stored therein) of the processor potentially combined with some software (e.g., higher-level instructions stored in memory). The workload and architectural state migration module is coupled with the heterogeneous physical cores and is logically disposed between the homogeneous virtual cores and the heterogeneous physical cores. In some embodiments, the workload and architectural state migration module may be operable to migrate, move, or remap threads, tasks, software processes, other workloads, and/or virtual cores, from an initially mapped or assigned heterogeneous physical core to another different type of heterogeneous physical core. For example, a thread scheduled by the software scheduler on a given homogeneous virtual core which the processor initially mapped or assigned to a first heterogeneous physical core may be migrated and remapped or reassigned to a second different type of heterogeneous physical core.

In some embodiments, the mapping or correspondence may be dynamically changed to avoid, or at least help to avoid, delivery of an interrupt, fault, exception, or other exceptional condition to software (e.g., an operating system module), which may otherwise occur when a workload currently mapped to a heterogeneous physical core needs a characteristic or capability that the currently mapped heterogeneous physical core does not have. For example, in some embodiments, when a workload running on a given homogeneous virtual core includes an instruction that is not supported by (e.g., is not included in the instruction set of) the currently mapped heterogeneous physical core, but is supported by (e.g., is included in the instruction set of or can be emulated by) a second different type of heterogeneous physical core, then the given homogeneous virtual core may be remapped to the second different type of heterogeneous physical core and/or the workload may be migrated to the second different type of heterogeneous physical core. The instruction may be performed (e.g., executed or emulated) on the second different type of heterogeneous physical core. As another example, in some embodiments, when a workload running on a given homogeneous virtual core desires or attempts to use a architectural feature that is not supported by the currently mapped heterogeneous physical core, but is supported by a second different type of heterogeneous physical core, then the given homogeneous virtual core may be remapped to the second different type of heterogeneous physical core and/or the workload may be migrated to the second different type of heterogeneous physical core. For example, this may be the case if the workload attempts to use an architectural security feature not supported by the currently mapped heterogeneous physical core but supported by the second different type of heterogeneous physical core. Such remapping or migration of the workload from the initially mapped heterogeneous physical core to the different type of heterogeneous physical core may help to avoid, or at least attempt to avoid, delivery of an interrupt, fault, exception, or other exceptional condition (e.g., an unsupported instruction fault, etc.) to software (e.g., an operating system), which may otherwise tend to occur due to characteristics or capabilities lacking in the initially mapped heterogeneous physical core.

Another example, involves a case where a system management mode (SMM) is not supported by all of the core types. A system management interrupt may occur in a physical core that does not support the SMM. The processor may need to migrate this interrupt to the physical core that includes the SMM support. Some architectural feature support may request direct access by any type of physical core into all of the types of physical cores resources in order to read or write specific information. The access from one physical core into another type of physical cores resources may desirably be transparent to the software (e.g., the operating system).

Advantageously, in some embodiments, the processor may be able to hide the heterogeneity of the physical cores from software (e.g., a software scheduler, an operating system, a virtual machine monitor, a micro-kernel, etc.). The software does not even need to know of the heterogeneity of the physical cores (e.g., they may be software invisible), or at least does not need to be the one to assign or map the threads or other workloads to the heterogeneous cores. Rather, legacy operating system or other software may continue to schedule threads or other workloads to the homogeneous virtual cores exposed by the processor without needing to be modified to be aware of the heterogeneous physical cores or their characteristics or attributes (e.g., what instructions or architectural features the heterogeneous physical cores support). The processor may instead map or assign, and remap or reassign, and migrate, the threads or other workloads among the heterogeneous physical cores with knowledge of their characteristics or attributes (e.g., what instructions or architectural features the heterogeneous physical cores support). In some embodiments, such remapping or migration may be used to avoid, or at least help or attempt to avoid, delivery of faults, interrupts or other exceptional conditions to software (e.g., an operating system), which would otherwise tend to occur due to unsupported instructions or architectural features encountered while processing the workloads on the heterogeneous physical cores. The processor may perform such migration or remapping transparently to the software and or in a software-invisible way.

To avoid obscuring the description, a relatively simple processor 108 has been shown and described. It is to be appreciated that the cores of the processor may optionally include other generally conventional components, such as, for example, an instruction fetch unit, an instruction scheduling unit, a branch prediction unit, instruction and data caches, instruction and data translation lookaside buffers, prefetch buffers, microinstruction queues, microinstruction sequencers, bus interface units, second or higher level caches, a retirement unit, a register renaming unit, other components included in processors, and various combinations thereof. There are literally numerous different combinations and configurations of components in processors, and embodiments are not limited to any particular combination or configuration. The processor may represent an integrated circuit or set of one or more semiconductor dies or chips (e.g., a single die or chip, or a package incorporating two or more die or chips). In some embodiments, the processor may represent a system-on-chip (SoC).

Various different models for using heterogeneous cores are contemplated. Often, two different types of heterogeneous physical cores may have similar or largely overlapping architectural features and instruction sets (i.e., often a majority of the instructions may be the same) but one type of core may support one or more additional architectural features and/or one or more additional instructions (e.g., one or more instruction set extensions). In some embodiments, one type of core may support all of the architectural features and instructions of all other cores, although this is not required.

In some embodiments, one type of core may be a relatively higher overall computational capability and/or relatively higher overall power consumption core and another type of core may be a relatively lower overall computational capability and/or relatively lower overall power consumption core. The overall means not just performing one type of task (e.g., floating point calculations or integer calculations) but rather a mix of different types of tasks associated with general-purpose computing. A core that supports more instructions and/or more architectural features often tends to have greater computational capability or throughput but also tends to have relatively more logic (e.g., to be relatively bigger) and often but not always to have relatively greater rates of power consumption. Conversely, a core that supports less instructions and/or less architectural features often tends to have relatively lesser computational capability or throughput but also tends to have relatively less logic (e.g., to be relatively smaller) and often have relatively lower rates of power consumption. For example, in some cases, a higher performance higher power consumption core may have larger caches and wider larger packed data registers (e.g., support wider packed data instructions) than a lower performance lower power consumption core. In one particular example, there may be a set of smaller physical cores (e.g., four) and a set of bigger physical cores (e.g., one or two) and a set of homogeneous virtual cores may be exposed to software (e.g., four). Operation on the smaller cores may tend to be more power efficient and may be favored when high performance is not needed and/or when operating on limited power, whereas operation on the bigger cores may tend to provide improved performance and may be favored when high performance is needed or when ample power is available. Remapping to the bigger cores may be performed when improved performance is desired, power is not an issue, and/or selectively when instructions or architectural features are needed. In some embodiments, the bigger cores may support a superset of instructions and architectural features supported by the smaller cores.

In other embodiments, one type of core or other compute element (e.g., fixed function accelerator, hardware accelerator, graphics accelerator, special-purpose processor, etc.) may be relatively more special-purpose than another, for example designed to be efficient at performing a certain task like web browsing, video compression and/or decompression, graphics processing, cryptographic tasks, or the like, and may omit certain instructions not needed for that more specialized task and/or may include additional instructions that are beneficial for that specialized task (e.g., a cryptographic, video compression/decompression, web browsing, or other type of specialized instruction set extension, etc.). As another example, a portion of the cores may support extra architectural security related instructions and/or features, extra architectural transactional memory or transactional execution related instructions and/or features, etc.

In still other embodiments, one type of core may have a relatively larger bit-width architecture (e.g., be a 64-bit core or a 128-bit core), whereas another type of core may be a relatively smaller bit-width architecture (e.g., be a 32-bit core or a 64-bit core). As a still further example, in some embodiments, one type of core may have a greater memory bandwidth than another type of core. These are just a few illustrative examples. Those skilled in the art and having the benefit of the present disclosure will appreciate other ways in which the cores may be heterogeneous.

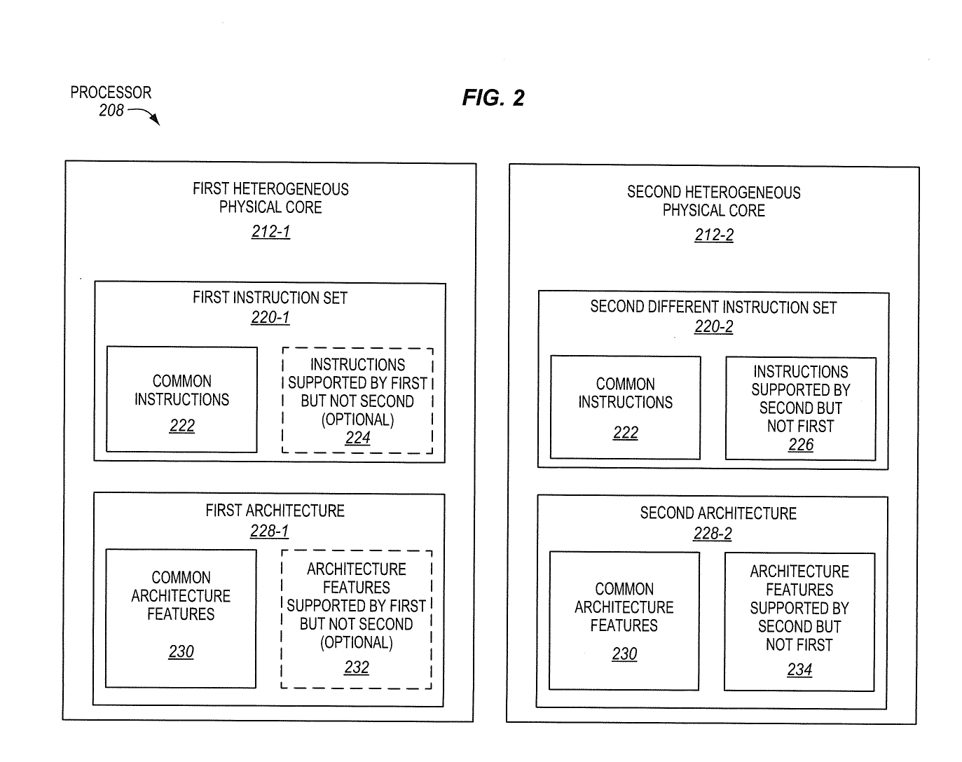

FIG. 2 is a block diagram of a processor 208 having an example embodiment of heterogeneous physical cores 212. The heterogeneous physical cores include a first heterogeneous physical core 212-1 and a second heterogeneous physical core 212-2. The first heterogeneous physical core has a first instruction set 220-1. The second heterogeneous physical core has a second different instruction set 220-2, which is at least partly different than the first instruction set. The first and second instruction sets each include a common set of instructions 222. As previously mentioned, in some embodiments, the common set of instructions may be at least a majority of the instructions of one and/or both of the instruction sets. The second instruction set includes a set of one or more instructions 226 that are supported by (e.g., capable of being decoded by) the second heterogeneous physical core but not by the first heterogeneous physical core. In some embodiments, the first instruction set may optionally include a set of one or more instructions 224 that are supported by (e.g., capable of being decoded by) the first heterogeneous physical core but not by the second heterogeneous physical core.

The first heterogeneous physical core also has a first architecture 228-1. The second heterogeneous physical core has a second different architecture 228-2, which is at least partly different than the first architecture. The first and second architectures each include a common set of architectural features 230. In some embodiments, the common set of architectural features may be at least a majority of the architectural features of one and/or both of the architectures. The second architecture includes a set of one or more architectural features 234 that are supported by the second heterogeneous physical core but not by the first heterogeneous physical core. In some embodiments, the first architecture may optionally include a set of one or more architectural features 232 that are supported by the first heterogeneous physical core but not by the second heterogeneous physical core.

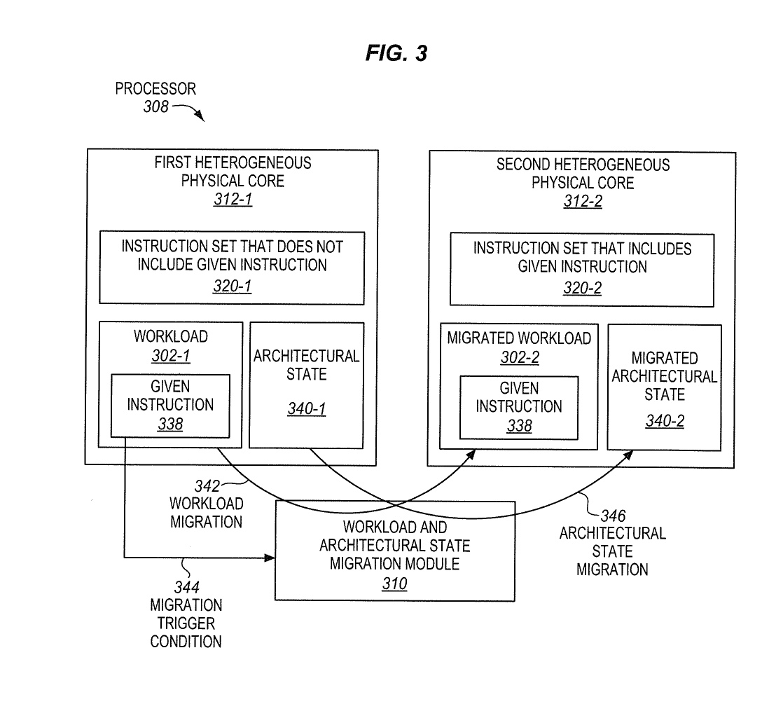

FIG. 3 is a block diagram of an embodiment of a processor 308 having heterogeneous physical cores 312 and a workload and architectural state migration module 310 to perform workload and architectural state migration based on an unsupported instruction. The heterogeneous physical cores include a first heterogeneous physical core 312-1 and a second heterogeneous physical core 312-2. The cores may be heterogeneous in the various ways previously described. The workload and architectural state migration module is coupled with the heterogeneous physical cores.

A workload 302-1 is initially/currently mapped, assigned, or otherwise corresponds to the first heterogeneous physical core 312-1. The workload includes a given instruction 338. An instruction set 320-1 of the first heterogeneous physical core does not include the given instruction. That is the given instruction is not supported by the instruction set of the first heterogeneous physical core. An attempt to process (e.g., decode and/or execute) the given instruction on the first heterogeneous physical core may generate a migration trigger condition 344. By way of example, the migration trigger condition may represent a signal or condition (e.g. a reporting of bits in a register). As an example, logic of a decode unit or coupled with a decode unit may generate the migration trigger condition in response to receiving an unrecognized opcode. The workload and architectural state migration module 310 may intercept or otherwise receive the migration trigger condition. In embodiments, migration trigger condition may be provided to the workload and architectural state migration module instead of delivering or reporting an unrecognized opcode interrupt or similar unrecognized instruction exceptional condition to software (e.g., an interrupt handler module or other portion of an operating system module). The migration trigger condition may at least conceptually represent a processor internal exceptional condition that is invisible to the software (e.g., to an operating system).

The workload and architectural state migration module may determine to perform a workload migration 342 based on the migration trigger condition. The workload migration may involve migrating or moving the workload 302-1 from the first heterogeneous physical core to the second heterogeneous physical core as a migrated workload 302-2. The second heterogeneous physical core has an instruction set 320-2 that includes the given instruction. That is the given instruction is supported by the instruction set 320-2 of the second heterogeneous physical core. In some embodiments, the workload and architectural state migration module may be aware that the instruction set 320-2 of the second heterogeneous physical core includes the given instruction. As one particular example, the instruction set 320-2 of the second heterogeneous physical core may be known to be a superset of the instruction set of the first heterogeneous physical core. The migrated workload 302-2 may be established and run on the second heterogeneous physical core. The given instruction 338 may be processed (e.g., decoded, executed, etc.) on the second heterogeneous physical core without causing an unrecognized opcode interrupt or similar unrecognized instruction exceptional condition.

The workload and architectural state migration module may also determine to perform an architectural state migration 346 based on the migration trigger condition. State is also sometimes referred to as context. The architectural state migration may involve migrating or moving architectural state 340-1 from the first heterogeneous physical core to the second heterogeneous physical core as a migrated architectural state 340-2. The architectural state may include content of architectural registers (e.g., general-purpose registers, packed data registers, configuration registers, status registers) and/or other similar architectural state known in the arts. While the migrated workload runs on the second heterogeneous physical core it may access and use and update the migrated architectural state.

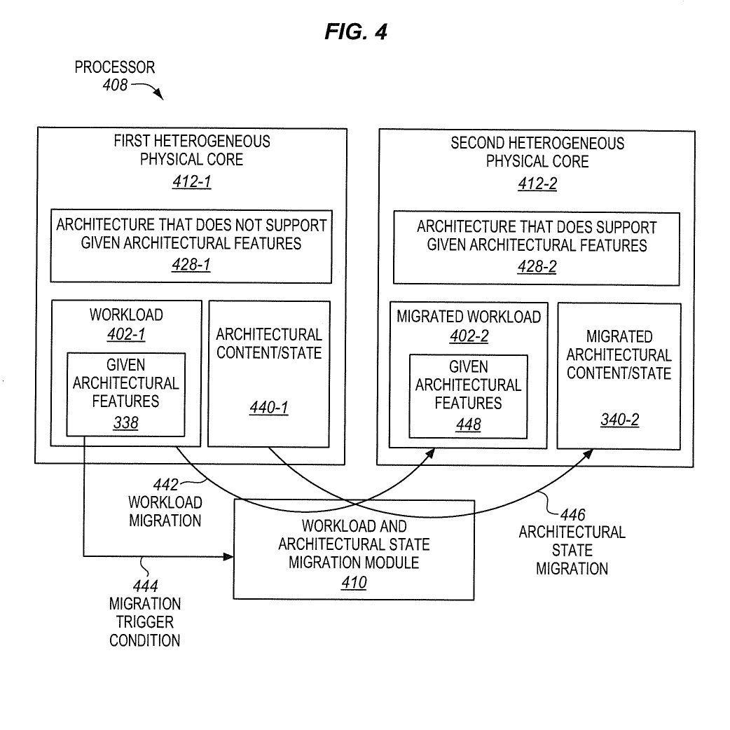

FIG. 4 is a block diagram of an embodiment of a processor 408 having heterogeneous physical cores 412 and a workload and architectural state migration module 410 to perform workload and architectural state migration based on an unsupported architectural feature. The heterogeneous physical cores include a first heterogeneous physical core 412-1 and a second heterogeneous physical core 412-2. The cores may be heterogeneous in the various ways previously described. The workload and architectural state migration module is coupled with the heterogeneous physical cores.

A workload 402-1 is initially/currently mapped, assigned, or otherwise corresponds to the first heterogeneous physical core. The workload desires or attempts to use a given architectural feature 448. An architecture 428-1 of the first heterogeneous physical core does not support the given architectural feature. By way of example, the architectural feature may represent a security feature, a transactional memory feature, hardware resource or operation mode, etc. An attempt to use the given architectural feature on the first heterogeneous physical core may generate a migration trigger condition 444. By way of example, the migration trigger condition may represent a signal or condition (e.g. a reporting of bits in a register). As an example, logic of a decode unit or coupled with a decode unit may generate the migration trigger condition in response to receiving an instruction involving an architectural feature that is not supported. Such a migration trigger condition may also potentially be generated by other pipeline components when at any point decoded instructions or control signals attempt to use an unsupported architectural feature. The workload and architectural state migration module 410 may intercept or otherwise receive the migration trigger condition. In embodiments, migration trigger condition may be provided to the workload and architectural state migration module instead of delivering or reporting an interrupt, fault, exception, or other exceptional condition to software (e.g., an interrupt handler module or other portion of an operating system module).

The workload and architectural state migration module may determine to perform a workload migration 442 based on the migration trigger condition. The workload migration may involve migrating or moving the workload 402-1 from the first heterogeneous physical core to the second heterogeneous physical core as a migrated workload 402-2. The second heterogeneous physical core has an architecture 428-2 that supports the given architectural feature. In some embodiments, the workload and architectural state migration module may be aware that the architecture 428-2 of the second heterogeneous physical core supports the given architectural feature. The migrated workload 402-2 may be established and run on the second heterogeneous physical core. The given architectural feature 448 may be accessed or used on the second heterogeneous physical core without causing an interrupt, fault, exception, or other exceptional condition.

The workload and architectural state migration module may also determine to perform an architectural state migration 446 based on the migration trigger condition. The architectural state migration may involve migrating or moving architectural state 440-1 from the first heterogeneous physical core to the second heterogeneous physical core as a migrated architectural state 440-2.

In some embodiments, there may be different numbers of homogeneous virtual cores and heterogeneous physical cores. For example, there may be more heterogeneous physical cores than homogeneous virtual cores. In such cases, often one or more heterogeneous physical cores may be idle, asleep, or otherwise in a relatively inactive or low power state. If migration is to be performed to a heterogeneous physical core that is idle, asleep, or otherwise relatively inactive, that heterogeneous physical core may be woken or otherwise activated, and then the workload and architectural state migration to that heterogeneous physical core may be performed substantially as described elsewhere herein.

In other embodiments, there may optionally be an equal number of homogeneous virtual cores and heterogeneous physical cores. When workloads are scheduled on all of the homogeneous virtual cores often all of the heterogeneous physical cores will also be busy. In embodiments where migration is to be performed to a heterogeneous physical core that is already busy processing another workload, then a workload swap may optionally be performed. During the workload swap, the workload currently being processed on the heterogeneous physical core may be swapped or migrated to another heterogeneous physical core. Then a workload in need of support for instructions or architectural features of that heterogeneous physical core may be migrated to that heterogeneous physical core. Alternatively, if both the existing and new workloads need support for the instruction or architectural feature of that heterogeneous physical core, then both workloads may optionally share that heterogeneous physical core. For example, the workloads may be added to a queue (e.g., a workload queue) and processed in a shared fashion (e.g., in a time-sliced or multiplexed fashion) from the queue.

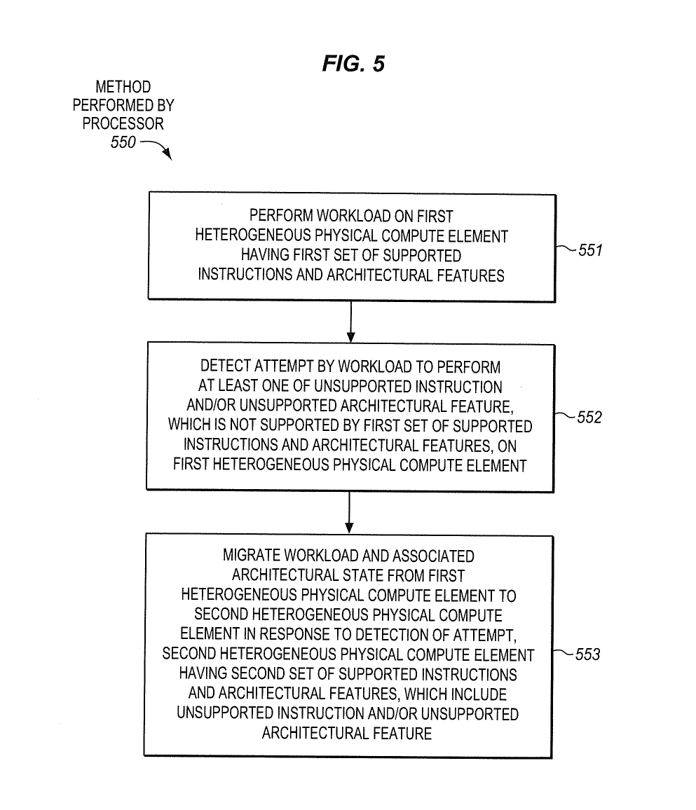

FIG. 5 is a block flow diagram of an embodiment of a method 550 performed by and/or within a processor. In some embodiments, the operations and/or method of FIG. 5 may be performed by and/or within the processors of any of FIGS. 1-4. The components, features, and specific optional details described herein for the processors also optionally apply to the operations and/or method, which may in embodiments be performed by and/or within the processors. Alternatively, the operations and/or method of FIG. 5 may be performed by and/or within similar or different processors. Moreover, the processors of any of FIGS. 1-4 may perform operations and/or methods that are the same, similar, or different than those of FIG. 5.

The method includes performing a workload on a first heterogeneous physical compute element having a first set of supported instructions and architectural features, at block 551. In some embodiments, the first heterogeneous physical compute element is a core of a first type.

The method includes detecting an attempt by the workload to perform at least one of an unsupported instruction and/or an unsupported architectural feature on the first heterogeneous physical compute element, at block 552. The unsupported instruction and/or the unsupported architectural feature are not supported by the first set of supported instructions and architectural features.

The method includes migrating the workload and associated architectural state from the first heterogeneous physical compute element to a second heterogeneous physical compute element in response to the detection of the attempt, at block 553. The second heterogeneous physical compute element has a second set of supported instructions and architectural features. In some embodiments, the second set of supported instructions and architectural features include the unsupported instruction and/or the unsupported architectural feature and/or both.

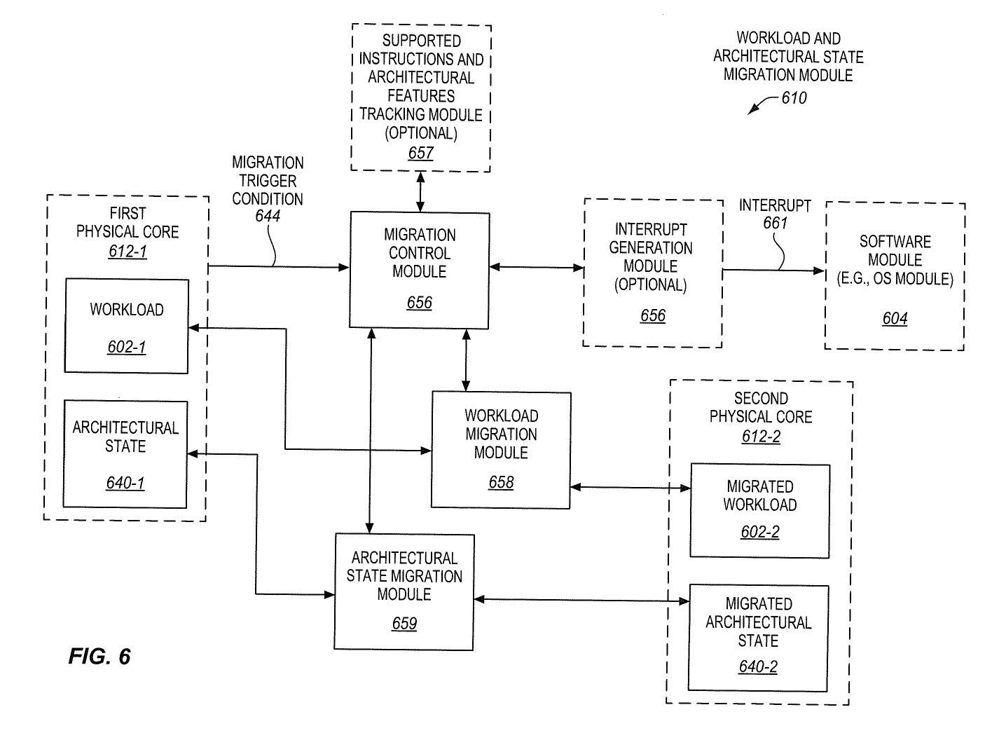

FIG. 6 is a block diagram of an example embodiment of a workload and architectural state migration module 610. Also shown for reference are a first heterogeneous physical core 612-1, a second heterogeneous physical core 612-2, and a software module 604 (e.g., an operating system module). The first physical core is running a workload 602-1, encounters an unsupported instruction or architectural feature, and causes a migration trigger condition 644 to be provided to the workload and architectural state migration module 610.

A migration control module 656 receives the migration trigger condition. The migration control module may be operable to determine a different heterogeneous physical core to migrate the workload and architectural context to. The way in which this is done generally depends on the number of different types of physical cores and/or how they are different. By way of example, in a simple scenario where there are only two core types and the migration trigger condition comes from a first type of core, then the migration control module may determine to migrate to the second different type of core. As another example, there may be one, two, three, or some other number of different types of “subset” cores that each support a slightly different subset of instructions and architectural features, and another “superset” core that supports a full superset of all of the subsets of instructions and architectural features. In such a case, one possible approach would be for the migration control module to determine to migrate to the superset core that supports the full set of instructions and features. If the attempt at the instruction or architectural feature on that superset core fails, the migration control module may decide to cause an exceptional condition to be reported to software (e.g., an operating system).

More sophisticated approaches are also contemplated. In some embodiments, the migration control module may optionally access an optional supported instructions and architectural features tracking module 657. The supported instructions and architectural features tracking module may track or record which instructions and architectural features are supported by which heterogeneous physical cores. In one specific example, the tracking module may include a matrix or table (e.g., a truth table) or similar set of data implemented in logic. By way of example, different instructions and feature modes may be listed in one dimension (e.g., the columns) and another dimension (e.g., the rows) may list the different heterogeneous physical cores or their types. According to one convention, binary ones in the table or matrix may be used to indicate if the corresponding instruction or architectural feature is supported by the corresponding heterogeneous physical core or type and binary zeroes would indicate lack of support. The migration control module may use the supported instructions and architectural features tracking module to intelligently select a heterogeneous physical core (e.g., the second physical core 612-2) that is known or believed to support the attempted instruction or architectural feature. For example, a lookup into the table, matrix, or hardware data structure may allow determining which physical cores or core types support a given instruction or architectural feature. In some cases, the migration may also be based on the whether the physical core is busy or its activity level (e.g., migration to an idle or inactive core may be favored over migration to an overly busy core).

In some embodiments, the migration trigger condition may explicitly specify or implicitly indicate the type of core where the migration trigger condition originated. This is optional but may also help to aid the migration control module in determining where to migrate. In some embodiments, the migration trigger condition may explicitly specify or implicitly indicate the instruction, type of instruction, or class of instructions or architectural feature, type of feature, or class of features that caused the migration trigger condition. This is optional but may also help to aid the migration control module in determining where to migrate. Alternatively the migration control module may have capability to determine such information.

Yet another suitable approach is simple trial and error in which the attempted instruction or architectural feature is tried on the different heterogeneous physical cores in some order (e.g., in a fixed order, in a random order, from least complex core to most complex core, etc.) until either one of the physical cores supports the instruction or architectural feature, or it is concluded that none of the physical cores supports the instruction or architectural feature. For example, a first heterogeneous physical core not to support an attempted instruction or architectural feature may record that it was tested on that core type and trigger migration to another heterogeneous physical core type. Similarly, each different core type may attempt the instruction or architectural feature, record that it was tested and failed, and trigger migration to another heterogeneous physical core type. By way of example, the migration control module may record (e.g., in a set of bits or a data structure or the like) whether or not support for the instruction or feature was tested on the different types of physical cores and whether or not the different types of physical cores supported the instruction or feature. This process may stop if one of the physical core types supports the instruction or architectural feature.

When it is determined to migrate (e.g., if one of the heterogeneous physical cores is known or believed to support the attempted instruction or architectural feature, or if trial and error is to be used, etc.), then the migration control module may signal or control a workload migration module 658 to perform a workload migration in which the workload 602-1 is migrated from the first heterogeneous physical core to the second heterogeneous physical core as a migrated workload 602-2. The migration control module may also signal or control an architectural state migration module 659 to perform an architectural state migration in which the architectural state 640-1 is migrated from the first heterogeneous physical core to the second heterogeneous physical core as a migrated architectural state 640-2.

Conversely, if none of the other heterogeneous physical cores is known or believed to support the attempted instruction or architectural feature, or if trial and error on all of the different types of cores has failed to discover a core that supports the relevant instruction or architectural feature, then the migration control module may signal or control an interrupt generation module 660 to generate an interrupt 661 (e.g., an unsupported instruction interrupt) to the software module 604 (e.g., an interrupt handler module). Software may then deal with the exceptional condition.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

in-Order and Out-of-Order Core Block Diagram

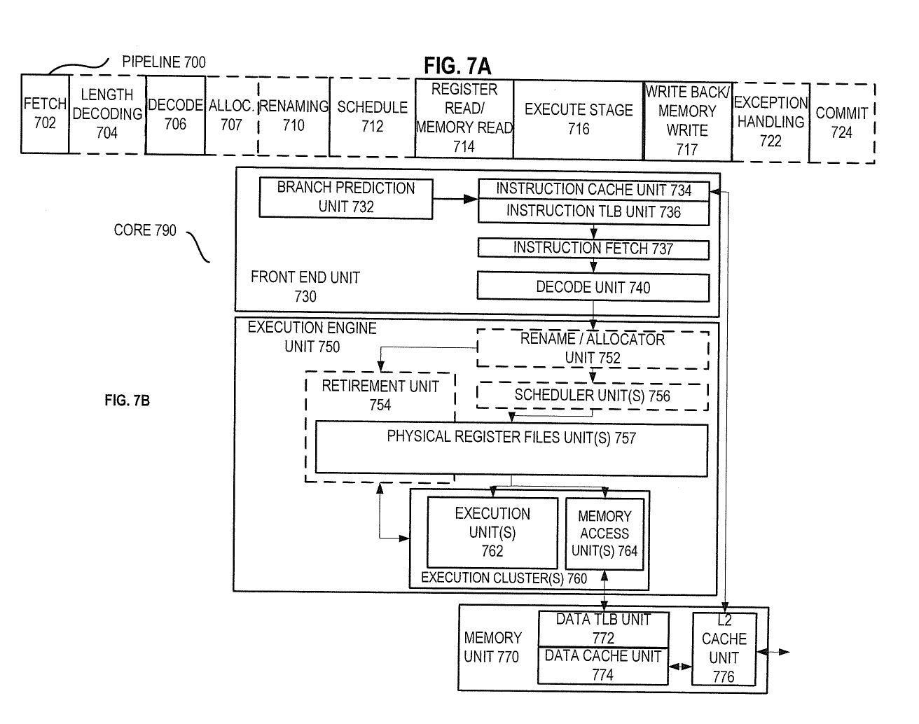

FIG. 7A is a block diagram illustrating both an exemplary in-order pipeline and an exemplary register renaming, out-of-order issue/execution pipeline according to embodiments of the invention. FIG. 7B is a block diagram illustrating both an exemplary embodiment of an in-order architecture core and an exemplary register renaming, out-of-order issue/execution architecture core to be included in a processor according to embodiments of the invention. The solid lined boxes in FIGS. 7A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 700 includes a fetch stage 702, a length decode stage 704, a decode stage 706, an allocation stage 708, a renaming stage 710, a scheduling (also known as a dispatch or issue) stage 712, a register read/memory read stage 714, an execute stage 716, a write back/memory write stage 718, an exception handling stage 722, and a commit stage 724.

FIG. 7B shows processor core 790 including a front end unit 730 coupled to an execution engine unit 750, and both are coupled to a memory unit 770. The core 790 may be a reduced instruction set computing (RISC) core, a complex instruction set computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front end unit 730 includes a branch prediction unit 732 coupled to an instruction cache unit 734, which is coupled to an instruction translation lookaside buffer (TLB) 736, which is coupled to an instruction fetch unit 738, which is coupled to a decode unit 740. The decode unit 740 (or decoder) may decode instructions, and generate as an output one or more micro-operations, micro-code entry points, microinstructions, other instructions, or other control signals, which are decoded from, or which otherwise reflect, or are derived from, the original instructions. The decode unit 740 may be implemented using various different mechanisms. Examples of suitable mechanisms include, but are not limited to, look-up tables, hardware implementations, programmable logic arrays (PLAs), microcode read only memories (ROMs), etc. In one embodiment, the core 790 includes a microcode ROM or other medium that stores microcode for certain macroinstructions (e.g., in decode unit 740 or otherwise within the front end unit 730). The decode unit 740 is coupled to a rename/allocator unit 752 in the execution engine unit 750.

The execution engine unit 750 includes the rename/allocator unit 752 coupled to a retirement unit 754 and a set of one or more scheduler unit(s) 756. The scheduler unit(s) 756 represents any number of different schedulers, including reservations stations, central instruction window, etc. The scheduler unit(s) 756 is coupled to the physical register file(s) unit(s) 758. Each of the physical register file(s) units 758 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 758 comprises a vector registers unit, a write mask registers unit, and a scalar registers unit. These register units may provide architectural vector registers, vector mask registers, and general purpose registers. The physical register file(s) unit(s) 758 is overlapped by the retirement unit 754 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 754 and the physical register file(s) unit(s) 758 are coupled to the execution cluster(s) 760. The execution cluster(s) 760 includes a set of one or more execution units 762 and a set of one or more memory access units 764. The execution units 762 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 756, physical register file(s) unit(s) 758, and execution cluster(s) 760 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 764). It should also be understood that where separate pipelines are used, one or more of these pipelines may be out-of-order issue/execution and the rest in-order.

The set of memory access units 764 is coupled to the memory unit 770, which includes a data TLB unit 772 coupled to a data cache unit 774 coupled to a level 2 (L2) cache unit 776. In one exemplary embodiment, the memory access units 764 may include a load unit, a store address unit, and a store data unit, each of which is coupled to the data TLB unit 772 in the memory unit 770. The instruction cache unit 734 is further coupled to a level 2 (L2) cache unit 776 in the memory unit 770. The L2 cache unit 776 is coupled to one or more other levels of cache and eventually to a main memory.

By way of example, the exemplary register renaming, out-of-order issue/execution core architecture may implement the pipeline 700 as follows: 1) the instruction fetch 738 performs the fetch and length decoding stages 702 and 704; 2) the decode unit 740 performs the decode stage 706; 3) the rename/allocator unit 752 performs the allocation stage 708 and renaming stage 710; 4) the scheduler unit(s) 756 performs the schedule stage 712; 5) the physical register file(s) unit(s) 758 and the memory unit 770 perform the register read/memory read stage 714; the execution cluster 760 perform the execute stage 716; 6) the memory unit 770 and the physical register file(s) unit(s) 758 perform the write back/memory write stage 718; 7) various units may be involved in the exception handling stage 722; and 8) the retirement unit 754 and the physical register file(s) unit(s) 758 perform the commit stage 724.

The core 790 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 790 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 734/774 and a shared L2 cache unit 776, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

Specific Exemplary in-Order Core Architecture

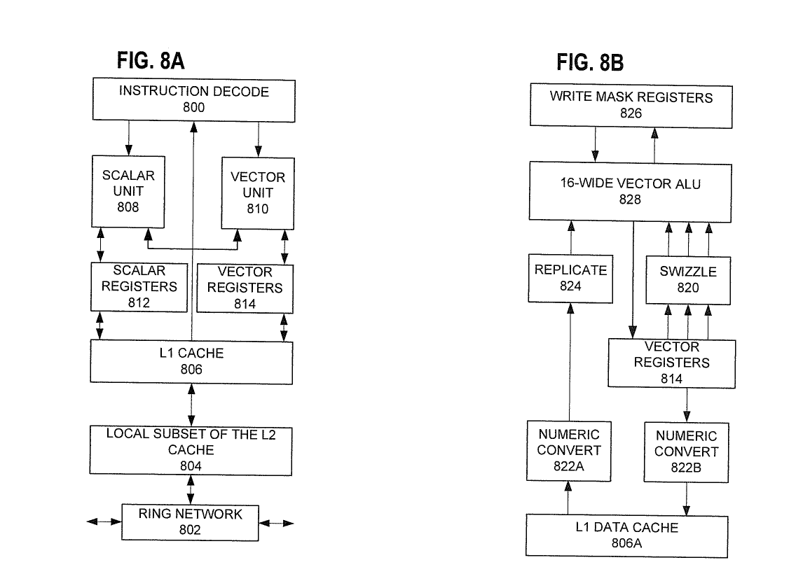

FIGS. 8A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 8A is a block diagram of a single processor core, along with its connection to the on-die interconnect network 802 and with its local subset of the Level 2 (L2) cache 804, according to embodiments of the invention. In one embodiment, an instruction decoder 800 supports the x86 instruction set with a packed data instruction set extension. An L1 cache 806 allows low-latency accesses to cache memory into the scalar and vector units. While in one embodiment (to simplify the design), a scalar unit 808 and a vector unit 810 use separate register sets (respectively, scalar registers 812 and vector registers 814) and data transferred between them is written to memory and then read back in from a level 1 (L1) cache 806, alternative embodiments of the invention may use a different approach (e.g., use a single register set or include a communication path that allow data to be transferred between the two register files without being written and read back).

The local subset of the L2 cache 804 is part of a global L2 cache that is divided into separate local subsets, one per processor core. Each processor core has a direct access path to its own local subset of the L2 cache 804. Data read by a processor core is stored in its L2 cache subset 804 and can be accessed quickly, in parallel with other processor cores accessing their own local L2 cache subsets. Data written by a processor core is stored in its own L2 cache subset 804 and is flushed from other subsets, if necessary. The ring network ensures coherency for shared data. The ring network is bidirectional to allow agents such as processor cores, L2 caches and other logic blocks to communicate with each other within the chip. Each ring data-path is 1012-bits wide per direction.

FIG. 8B is an expanded view of part of the processor core in FIG. 8A according to embodiments of the invention. FIG. 8B includes an L1 data cache 806A part of the L1 cache 804, as well as more detail regarding the vector unit 810 and the vector registers 814. Specifically, the vector unit 810 is a 16-wide vector processing unit (VPU) (see the 16-wide ALU 828), which executes one or more of integer, single-precision float, and double-precision float instructions. The VPU supports swizzling the register inputs with swizzle unit 820, numeric conversion with numeric convert units 822A-B, and replication with replication unit 824 on the memory input. Write mask registers 826 allow predicating resulting vector writes.

Processor with Integrated Memory Controller and Graphics

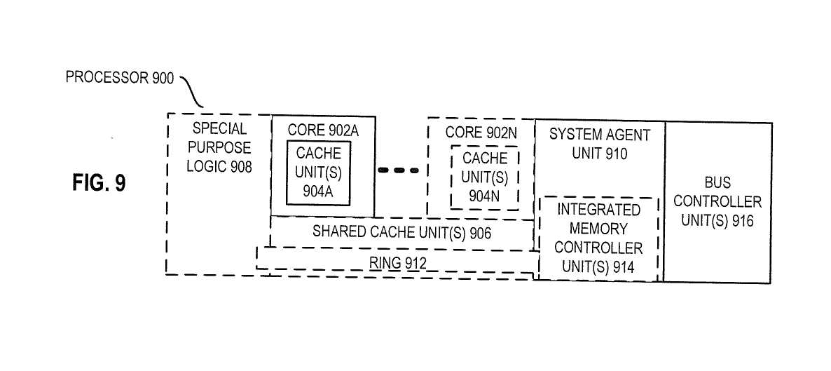

FIG. 9 is a block diagram of a processor 900 that may have more than one core, may have an integrated memory controller, and may have integrated graphics according to embodiments of the invention. The solid lined boxes in FIG. 9 illustrate a processor 900 with a single core 902A, a system agent 910, a set of one or more bus controller units 916, while the optional addition of the dashed lined boxes illustrates an alternative processor 900 with multiple cores 902A-N, a set of one or more integrated memory controller unit(s) 914 in the system agent unit 910, and special purpose logic 908.

Thus, different implementations of the processor 900 may include: 1) a CPU with the special purpose logic 908 being integrated graphics and/or scientific (throughput) logic (which may include one or more cores), and the cores 902A-N being one or more general purpose cores (e.g., general purpose in-order cores, general purpose out-of-order cores, a combination of the two); 2) a coprocessor with the cores 902A-N being a large number of special purpose cores intended primarily for graphics and/or scientific (throughput); and 3) a coprocessor with the cores 902A-N being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 906, and external memory (not shown) coupled to the set of integrated memory controller units 914. The set of shared cache units 906 may include one or more mid-level caches, such as level 2 (L2), level 3 (L3), level 4 (L4), or other levels of cache, a last level cache (LLC), and/or combinations thereof. While in one embodiment a ring based interconnect unit 912 interconnects the integrated graphics logic 908, the set of shared cache units 906, and the system agent unit 910/integrated memory controller unit(s) 914, alternative embodiments may use any number of well-known techniques for interconnecting such units. In one embodiment, coherency is maintained between one or more cache units 906 and cores 902-A-N.

In some embodiments, one or more of the cores 902A-N are capable of multithreading. The system agent 910 includes those components coordinating and operating cores 902A-N. The system agent unit 910 may include for example a power control unit (PCU) and a display unit. The PCU may be or include logic and components needed for regulating the power state of the cores 902A-N and the integrated graphics logic 908. The display unit is for driving one or more externally connected displays.

The cores 902A-N may be homogenous or heterogeneous in terms of architecture instruction set; that is, two or more of the cores 902A-N may be capable of execution the same instruction set, while others may be capable of executing only a subset of that instruction set or a different instruction set.

### Exemplary Computer Architectures

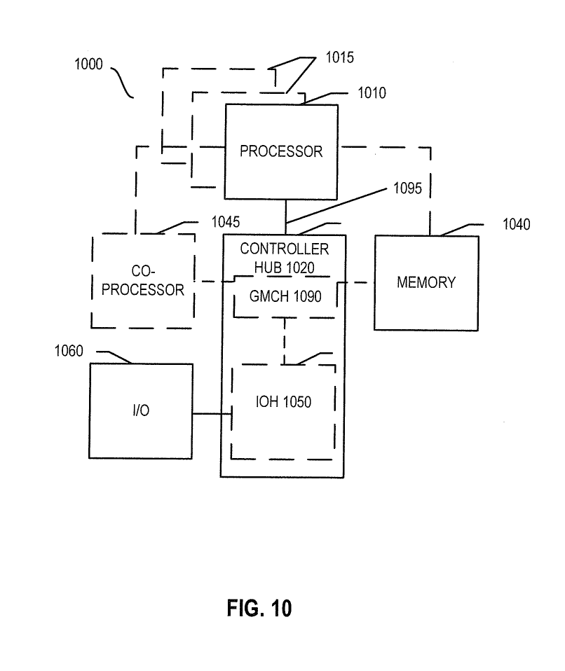

FIGS. 10-13 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 10, shown is a block diagram of a system 1000 in accordance with one embodiment of the present invention. The system 1000 may include one or more processors 1010, 1015, which are coupled to a controller hub 1020. In one embodiment the controller hub 1020 includes a graphics memory controller hub (GMCH) 1090 and an Input/Output Hub (IOH) 1050 (which may be on separate chips); the GMCH 1090 includes memory and graphics controllers to which are coupled memory 1040 and a coprocessor 1045; the IOH 1050 is couples input/output (I/O) devices 1060 to the GMCH 1090. Alternatively, one or both of the memory and graphics controllers are integrated within the processor (as described herein), the memory 1040 and the coprocessor 1045 are coupled directly to the processor 1010, and the controller hub 1020 in a single chip with the IOH 1050.

The optional nature of additional processors 1015 is denoted in FIG. 10 with broken lines. Each processor 1010, 1015 may include one or more of the processing cores described herein and may be some version of the processor 900.

The memory 1040 may be, for example, dynamic random access memory (DRAM), phase change memory (PCM), or a combination of the two. For at least one embodiment, the controller hub 1020 communicates with the processor(s) 1010, 1015 via a multi-drop bus, such as a frontside bus (FSB), point-to-point interface such as QuickPath Interconnect (QPI), or similar connection 1095.

In one embodiment, the coprocessor 1045 is a special-purpose processor, such as, for example, a high-throughput MIC processor, a network or communication processor, compression engine, graphics processor, GPGPU, embedded processor, or the like. In one embodiment, controller hub 1020 may include an integrated graphics accelerator.

There can be a variety of differences between the physical resources 1010, 1015 in terms of a spectrum of metrics of merit including architectural, microarchitectural, thermal, power consumption characteristics, and the like.

In one embodiment, the processor 1010 executes instructions that control data processing operations of a general type. Embedded within the instructions may be coprocessor instructions. The processor 1010 recognizes these coprocessor instructions as being of a type that should be executed by the attached coprocessor 1045. Accordingly, the processor 1010 issues these coprocessor instructions (or control signals representing coprocessor instructions) on a coprocessor bus or other interconnect, to coprocessor 1045. Coprocessor(s) 1045 accept and execute the received coprocessor instructions.

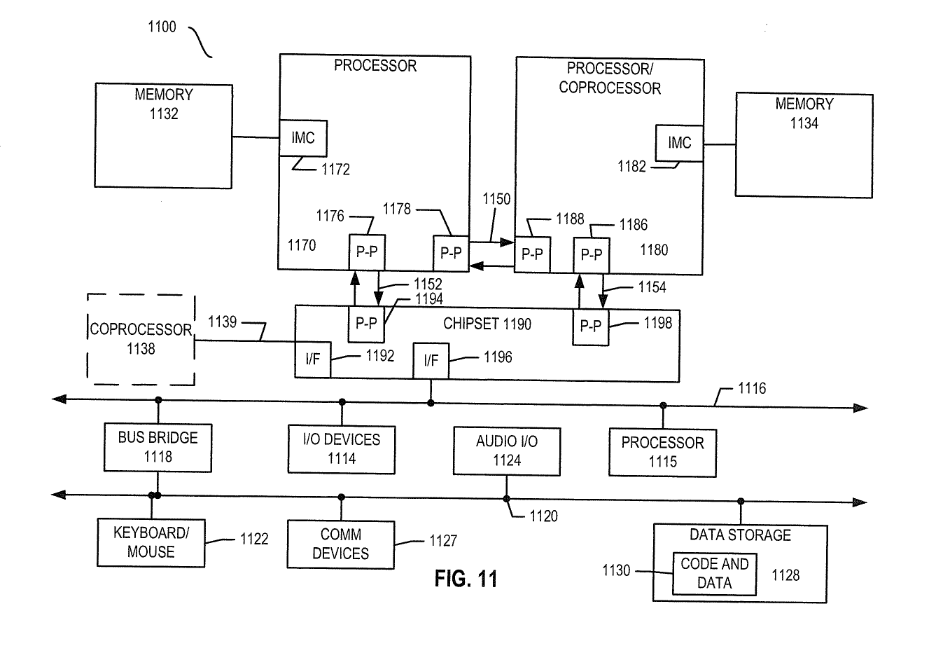

Referring now to FIG. 11, shown is a block diagram of a first more specific exemplary system 1100 in accordance with an embodiment of the present invention. As shown in FIG. 11, multiprocessor system 1100 is a point-to-point interconnect system, and includes a first processor 1170 and a second processor 1180 coupled via a point-to-point interconnect 1150. Each of processors 1170 and 1180 may be some version of the processor 900. In one embodiment of the invention, processors 1170 and 1180 are respectively processors 1010 and 1015, while coprocessor 1138 is coprocessor 1045. In another embodiment, processors 1170 and 1180 are respectively processor 1010 coprocessor 1045.

Processors 1170 and 1180 are shown including integrated memory controller (IMC) units 1172 and 1182, respectively. Processor 1170 also includes as part of its bus controller units point-to-point (P-P) interfaces 1176 and 1178; similarly, second processor 1180 includes P-P interfaces 1186 and 1188. Processors 1170, 1180 may exchange information via a point-to-point (P-P) interface 1150 using P-P interface circuits 1178, 1188. As shown in FIG. 11, IMCs 1172 and 1182 couple the processors to respective memories, namely a memory 1132 and a memory 1134, which may be portions of main memory locally attached to the respective processors.

Processors 1170, 1180 may each exchange information with a chipset 1190 via individual P-P interfaces 1152, 1154 using point to point interface circuits 1176, 1194, 1186, 1198. Chipset 1190 may optionally exchange information with the coprocessor 1138 via a high-performance interface 1139. In one embodiment, the coprocessor 1138 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1190 may be coupled to a first bus 1116 via an interface 1196. In one embodiment, first bus 1116 may be a Peripheral Component Interconnect (PCI) bus, or a bus such as a PCI Express bus or another third generation I/O interconnect bus, although the scope of the present invention is not so limited.

As shown in FIG. 11, various I/O devices 1114 may be coupled to first bus 1116, along with a bus bridge 1118 which couples first bus 1116 to a second bus 1120. In one embodiment, one or more additional processor(s) 1115, such as coprocessors, high-throughput MIC processors, GPGPU's, accelerators (such as, e.g., graphics accelerators or digital signal processing (DSP) units), field programmable gate arrays, or any other processor, are coupled to first bus 1116. In one embodiment, second bus 1120 may be a low pin count (LPC) bus. Various devices may be coupled to a second bus 1120 including, for example, a keyboard and/or mouse 1122, communication devices 1127 and a storage unit 1128 such as a disk drive or other mass storage device which may include instructions/code and data 1130, in one embodiment. Further, an audio I/O 1124 may be coupled to the second bus 1120. Note that other architectures are possible. For example, instead of the point-to-point architecture of FIG. 11, a system may implement a multi-drop bus or other such architecture.

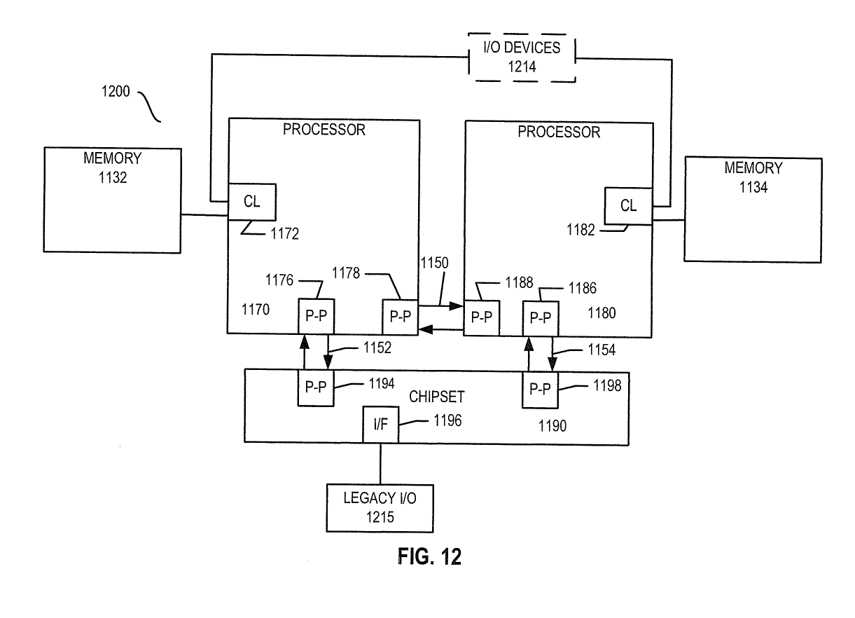

Referring now to FIG. 12, shown is a block diagram of a second more specific exemplary system 1200 in accordance with an embodiment of the present invention Like elements in FIGS. 11 and 12 bear like reference numerals, and certain aspects of FIG. 11 have been omitted from FIG. 12 in order to avoid obscuring other aspects of FIG. 12.

FIG. 12 illustrates that the processors 1170, 1180 may include integrated memory and I/O control logic (“CL”) 1172 and 1182, respectively. Thus, the CL 1172, 1182 include integrated memory controller units and include I/O control logic. FIG. 12 illustrates that not only are the memories 1132, 1134 coupled to the CL 1172, 1182, but also that I/O devices 1214 are also coupled to the control logic 1172, 1182. Legacy I/O devices 1215 are coupled to the chipset 1190.

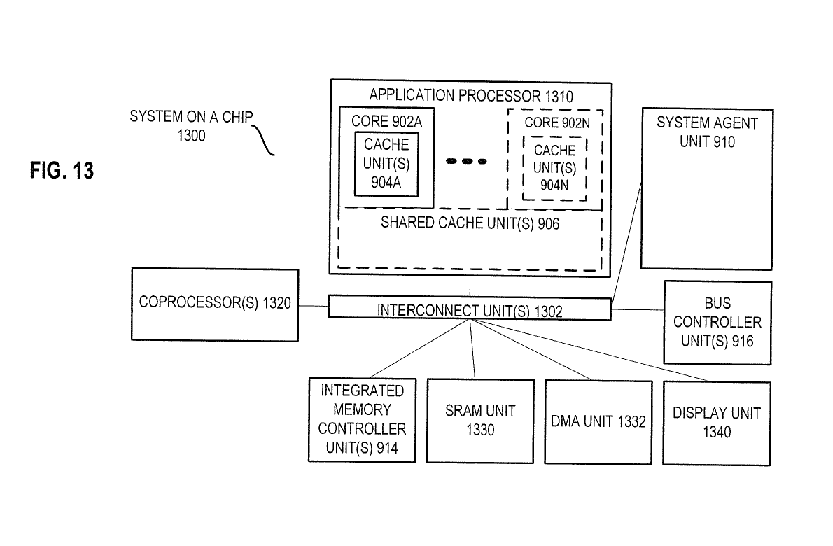

Referring now to FIG. 13, shown is a block diagram of a SoC 1300 in accordance with an embodiment of the present invention. Similar elements in FIG. 9 bear like reference numerals. Also, dashed lined boxes are optional features on more advanced SoCs. In FIG. 13, an interconnect unit(s) 1302 is coupled to: an application processor 1310 which includes a set of one or more cores 202A-N and shared cache unit(s) 906; a system agent unit 910; a bus controller unit(s) 916; an integrated memory controller unit(s) 914; a set or one or more coprocessors 1320 which may include integrated graphics logic, an image processor, an audio processor, and a video processor; an static random access memory (SRAM) unit 1330; a direct memory access (DMA) unit 1332; and a display unit 1340 for coupling to one or more external displays. In one embodiment, the coprocessor(s) 1320 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1130 illustrated in FIG. 11, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

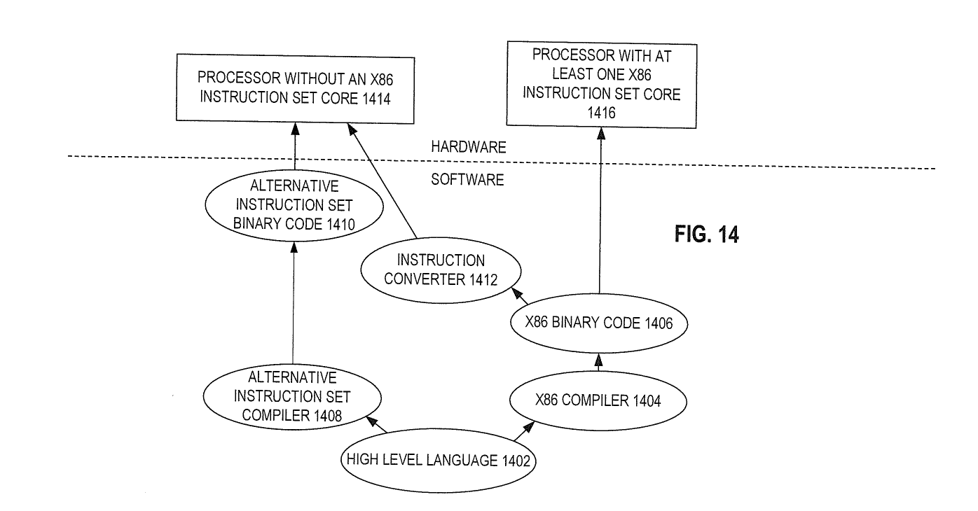

FIG. 14 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 14 shows a program in a high level language 1402 may be compiled using an x86 compiler 1404 to generate x86 binary code 1406 that may be natively executed by a processor with at least one x86 instruction set core 1416. The processor with at least one x86 instruction set core 1416 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1404 represents a compiler that is operable to generate x86 binary code 1406 (e.g., object code) that can, with or without additional linkage processing, be executed on the processor with at least one x86 instruction set core 1416. Similarly, FIG. 14 shows the program in the high level language 1402 may be compiled using an alternative instruction set compiler 1408 to generate alternative instruction set binary code 1410 that may be natively executed by a processor without at least one x86 instruction set core 1414 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1412 is used to convert the x86 binary code 1406 into code that may be natively executed by the processor without an x86 instruction set core 1414. This converted code is not likely to be the same as the alternative instruction set binary code 1410 because an instruction converter capable of this is difficult to make; however, the converted code will accomplish the general operation and be made up of instructions from the alternative instruction set. Thus, the instruction converter 1412 represents software, firmware, hardware, or a combination thereof that, through emulation, simulation or any other process, allows a processor or other electronic device that does not have an x86 instruction set processor or core to execute the x86 binary code 1406.

Components, features, and details described for any of FIGS. 2-4 may also optionally be used in FIG. 1 and/or FIG. 5. Moreover, components, features, and details described herein for any of the processors may also optionally be used in any of the methods or operations described herein, which in embodiments may be performed by and/or with such processors.

In the description and claims, the term “logic” may have been used. As used herein, the term logic may include but is not limited to hardware, firmware, software, or a combination thereof. Examples of logic include integrated circuitry, application specific integrated circuits, analog circuits, digital circuits, programmed logic devices, memory devices including instructions, etc. In some embodiments, the logic may include transistors and/or gates potentially along with other circuitry components.

In the description and claims, the terms “coupled” and “connected,” along with their derivatives, may have been used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. In the drawings, arrows represent couplings and bidirectional arrows represent bidirectional couplings.

The term “and/or” may have been used. As used herein, the term “and/or” means one or the other or both (e.g., A and/or B means A or B or both A and B).

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. All equivalent relationships to those illustrated in the drawings and described in the specification are encompassed within embodiments of the invention. In other instances, well-known circuits, structures, devices, and operations have been shown in block diagram form or without detail in order to avoid obscuring the understanding of the description. Where considered appropriate, reference numerals or terminal portions of reference numerals have been repeated among the figures to indicate corresponding or analogous elements that may optionally have similar or the same characteristics, unless specified or clearly apparent otherwise.

Various operations and methods have been described. Some of the methods have been described in a relatively basic form in the flow diagrams, but operations may optionally be added to and/or removed from the methods. In addition, while the flow diagrams show a particular order of the operations according to example embodiments, it is to be understood that that particular order is exemplary. Alternate embodiments may optionally perform the operations in different order, combine certain operations, overlap certain operations, etc.

It should also be appreciated that reference throughout this specification to “one embodiment”, “an embodiment”, or “one or more embodiments”, for example, means that a particular feature may be included in the practice of the invention. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

### Example Embodiments

The following examples pertain to further embodiments. Specifics in the examples may be used anywhere in one or more embodiments.

Example 1 is a processor including a first heterogeneous physical compute element having a first set of supported instructions and architectural features, and a second heterogeneous physical compute element having a second set of supported instructions and architectural features. The second set of supported instructions and architectural features is different than the first set of supported instructions and architectural features. A workload and architectural state migration module is coupled with the first and second heterogeneous physical compute elements. The workload and state migration module is to migrate a workload and associated architectural state from the first heterogeneous physical compute element to the second heterogeneous physical compute element in response to an attempt by the workload to perform at least one of an unsupported instruction and an unsupported architectural feature on the first heterogeneous physical compute element.

Example 2 includes the processor of Example 1, optionally in which the workload and architectural state migration module is to migrate the workload and the associated architectural state to the second heterogeneous physical compute element in response to the attempt to perform the unsupported instruction that is not included in the first set of supported instructions and architectural features.

Example 3 includes the processor of Example 2, optionally in which the workload and architectural state migration module is be notified of the attempt to perform the unsupported instruction without a corresponding exceptional condition being provided to software.

Example 4 includes the processor of Example 1, optionally in which the workload and architectural state migration module is to migrate the workload and the associated architectural state to the second heterogeneous physical compute element in response to the attempt to perform the unsupported architectural feature that is not included in the first set of supported instructions and architectural features.

Example 5 includes the processor of any preceding Example, optionally in which a majority of instructions of the first set of supported instructions are in the second set of supported instructions.

Example 6 includes the processor of any preceding Example, optionally in which the workload and architectural state migration module is to migrate the workload and the associated architectural state transparently to software that is to have scheduled the workload on the processor.

Example 7 includes the processor of any preceding Example, optionally in which the processor is to expose a plurality of homogeneous virtual cores to software that is to schedule workloads on the plurality of homogeneous virtual cores, and optionally in which the plurality of homogeneous virtual cores are to appear to the software to support identical sets of instructions and architectural features.

Example 8 includes the processor of any preceding Example, optionally in which the second set of supported instructions and architectural features is a superset of the first set of supported instructions and architectural features.

Example 9 includes the processor of any preceding Example, optionally in which the first and second heterogeneous physical compute elements comprise cores.

Example 10 includes the processor of any preceding Example, optionally in which the first heterogeneous physical compute element includes a relatively lower overall power consumption and relatively lower overall computation capability core, optionally in which the second heterogeneous physical compute element includes a relatively higher overall power consumption and relatively higher overall computation capability core.

Example 11 includes the processor of any preceding Example, optionally in which the workload and architectural state migration module is to maintain information about which instructions and which architectural features are supported by the second heterogeneous physical compute element.

Example 12 is a method performed by a processor including performing a workload on a first heterogeneous physical compute element having a first set of supported instructions and architectural features. The method also includes detecting an attempt by the workload to perform at least one of an unsupported instruction and an unsupported architectural feature, the at least one not supported by the first set of supported instructions and architectural features, on the first heterogeneous physical compute element. The method also includes migrating the workload and associated architectural state from the first heterogeneous physical compute element to a second heterogeneous physical compute element in response to the detection of the attempt. The second heterogeneous physical compute element has a second set of supported instructions and architectural features, which include the at least one of the unsupported instruction and the unsupported architectural feature.

Example 13 includes the method of Example 12, optionally in which detecting includes detecting the attempt to perform the unsupported instruction which is not included in the first set of supported instructions and architectural features, and optionally in which the unsupported instruction is included in the second set of supported instructions and architectural features.

Example 14 includes the method of Example 13, optionally in which migrating includes migrating the workload without an exceptional condition being provided to software as a result of the attempt to perform the unsupported instruction.

Example 15 includes the method of Example 12, optionally in which detecting includes detecting the attempt to perform the unsupported architectural feature which is not included in the first set of supported instructions and architectural features, and optionally in which the unsupported architectural feature is included in the second set of supported instructions and architectural features.

Example 16 includes the method of any preceding Example, optionally in which a majority of instructions of the first set of supported instructions and architectural features are included in the second set of supported instructions and architectural features.

Example 17 includes the method of any preceding Example, optionally in which migrating includes migrating the workload and architectural state transparently to software that is to have scheduled the workload on the processor.

Example 18 includes the method of any preceding Example, further including exposing a plurality of homogeneous virtual cores to software that is to schedule workloads on the plurality of homogeneous virtual cores.

Example 19 includes the method of any preceding Example, optionally in which migrating includes migrating to the second heterogeneous physical compute element having the second set of supported instructions and architectural features that is a superset of the first set of supported instructions and architectural features.

Example 20 includes the method of any preceding Example, optionally in which migrating includes migrating from a relatively lower overall power consumption and relatively lower overall computation capability core to a relatively higher overall power consumption and relatively higher overall computation capability core.

Example 21 includes the method of any preceding Example, further including maintaining information in the processor about which instructions and which architectural features are supported by the second heterogeneous physical compute element.

Example 22 includes a system to process instructions. The system includes an interconnect, a dynamic random access memory (DRAM) coupled with the interconnect, and a processor coupled with the interconnect. The processor includes a first heterogeneous physical core having a first instruction set, and a second heterogeneous physical core having a second instruction set that is different than the first instruction set. The processor also includes a workload and architectural state migration module coupled with the first and second heterogeneous physical cores. The workload and state migration module is to migrate a workload and associated architectural state from the first heterogeneous physical core to the second heterogeneous physical core in response to an attempt by the workload to perform an unsupported instruction that is not included in the first instruction set on the first heterogeneous physical core.

Example 23 includes the system of claim 22, optionally in which the second instruction set is a superset of the first instruction set, and optionally in which the first heterogeneous physical core includes a relatively lower power consumption and relatively lower computation capability core and the second heterogeneous physical core includes a relatively higher power consumption and relatively higher computation capability core.

Example 24 is a processor to perform the method of any of Examples 12-21.

Example 25 is a processor including means for performing the method of any of Examples 12-21.

Example 26 is a processor including integrated circuitry and/or logic and/or units and/or components and/or modules, or any combination thereof, to perform the methods of any of Examples 12-21.

Example 27 is a computer system including at least one processor and optionally a dynamic random access memory (DRAM), the computer system to perform the method of any of Examples 12-21.

Example 28 is a processor to perform one or more operations or a method substantially as described herein.

Example 29 is a processor including means for performing one or more operations or a method substantially as described herein.

What is claimed is:

1. A processor comprising:
a first heterogeneous physical compute element having a first set of supported instructions and architectural features;
a second heterogeneous physical compute element having a second set of supported instructions and architectural features, the second set of supported instructions and architectural features being different than the first set of supported instructions and architectural features; and
a workload and architectural state migration module coupled with the first and second heterogeneous physical compute elements, the workload and state migration module to migrate a workload and associated architectural state from the first heterogeneous physical compute element to the second heterogeneous physical compute element in response to an attempt by the workload to perform at least one of an unsupported instruction and an unsupported architectural feature on the first heterogeneous physical compute element.

2. The processor of claim 1, wherein the workload and architectural state migration module is to migrate the workload and the associated architectural state to the second heterogeneous physical compute element in response to the attempt to perform the unsupported instruction that is not included in the first set of supported instructions and architectural features.

3. The processor of claim 2, wherein the workload and architectural state migration module is be notified of the attempt to perform the unsupported instruction without a corresponding exceptional condition being provided to software.

4. The processor of claim 1, wherein the workload and architectural state migration module is to migrate the workload and the associated architectural state to the second heterogeneous physical compute element in response to the attempt to perform the unsupported architectural feature that is not included in the first set of supported instructions and architectural features.

5. The processor of claim 1, wherein a majority of instructions of the first set of supported instructions are in the second set of supported instructions.

6. The processor of claim 1, wherein the workload and architectural state migration module is to migrate the workload and the associated architectural state transparently to software that is to have scheduled the workload on the processor.

7. The processor of claim 1, wherein the processor is to expose a plurality of homogeneous virtual cores to software that is to schedule workloads on the plurality of homogeneous virtual cores, and wherein the plurality of homogeneous virtual cores are to appear to the software to support identical sets of instructions and architectural features.

8. The processor of claim 1, wherein the second set of supported instructions and architectural features is a superset of the first set of supported instructions and architectural features.

9. The processor of claim 1, wherein the first and second heterogeneous physical compute elements comprise cores.

10. The processor of claim 1, wherein the first heterogeneous physical compute element comprises a relatively lower overall power consumption and relatively lower overall computation capability core, wherein the second heterogeneous physical compute element comprises a relatively higher overall power consumption and relatively higher overall computation capability core.

11. The processor of claim 1, wherein the workload and architectural state migration module is to maintain information about which instructions and which architectural features are supported by the second heterogeneous physical compute element.

12. A method performed by a processor comprising:
performing a workload on a first heterogeneous physical compute element having a first set of supported instructions and architectural features;
detecting an attempt by the workload to perform at least one of an unsupported instruction and an unsupported architectural feature, the at least one not supported by the first set of supported instructions and architectural features, on the first heterogeneous physical compute element; and
migrating the workload and associated architectural state from the first heterogeneous physical compute element to a second heterogeneous physical compute element in response to the detection of the attempt, the second heterogeneous physical compute element having a second set of supported instructions and architectural features, which include the at least one of the unsupported instruction and the unsupported architectural feature.

13. The method of claim 12, wherein detecting comprises detecting the attempt to perform the unsupported instruction which is not included in the first set of supported instructions and architectural features, and wherein the unsupported instruction is included in the second set of supported instructions and architectural features.

14. The method of claim 13, wherein migrating comprises migrating the workload without an exceptional condition being provided to software as a result of the attempt to perform the unsupported instruction.

15. The method of claim 12, wherein detecting comprises detecting the attempt to perform the unsupported architectural feature which is not included in the first set of supported instructions and architectural features, and wherein the unsupported architectural feature is included in the second set of supported instructions and architectural features.

16. The method of claim 12, wherein a majority of instructions of the first set of supported instructions and architectural features are included in the second set of supported instructions and architectural features.

17. The method of claim 12, wherein migrating comprises migrating the workload and architectural state transparently to software that is to have scheduled the workload on the processor.

18. The method of claim 12, further comprising exposing a plurality of homogeneous virtual cores to software that is to schedule workloads on the plurality of homogeneous virtual cores.

19. The method of claim 12, wherein migrating comprises migrating to the second heterogeneous physical compute element having the second set of supported instructions and architectural features that is a superset of the first set of supported instructions and architectural features.

20. The method of claim 12, wherein migrating comprises migrating from a relatively lower overall power consumption and relatively lower overall computation capability core to a relatively higher overall power consumption and relatively higher overall computation capability core.

21. The method of claim 12, further comprising maintaining information in the processor about which instructions and which architectural features are supported by the second heterogeneous physical compute element.

22. A system to process instructions comprising:
an interconnect;
a dynamic random access memory (DRAM) coupled with the interconnect; and
a processor coupled with the interconnect, the processor comprising:
a first heterogeneous physical core having a first instruction set;
a second heterogeneous physical core having a second instruction set that is different than the first instruction set; and
a workload and architectural state migration module coupled with the first and second heterogeneous physical cores, the workload and state migration module to migrate a workload and associated architectural state from the first heterogeneous physical core to the second heterogeneous physical core in response to an attempt by the workload to perform an unsupported instruction that is not included in the first instruction set on the first heterogeneous physical core.

23. The system of claim 22, wherein the second instruction set is a superset of the first instruction set, and wherein the first heterogeneous physical core comprises a relatively lower power consumption and relatively lower computation capability core and the second heterogeneous physical core comprises a relatively higher power consumption and relatively higher computation capability core.
